(19) United States
(12) Patent Application Publication
(10) Pub. No.: US 2009/0028314 A1
(43) Pub. Date: Jan. 29, 2009

(54) SYSTEM AND METHOD TO IDENTIFY THE OPERATOR OF A CALL NUMBER STORED IN MEMORY IN A USER'S TERMINAL

(75) Inventor: Christian Faisy, La Montagne (FR)

Correspondence Address: PERMAN & GREEN, 425 POST ROAD, FAIRFIELD, CT, 06824, US

(73) Assignee: SOCIETE FRANCAISE DU RADIOTELEPHONE, Paris (FR)

(21) Appl. No.: 12/131,025

(22) Filed: May 30, 2008

(30) Foreign Application Priority Data
Jun. 1, 2007 (FR) 07/03916

(51) Int. Cl. H04M 3/42

(52) U.S. Cl. 379/201.12

(57) ABSTRACT

A system to identify the operator of at least one call number stored in memory in a user terminal, the system including: at least one terminal, a SIM Tool Kit application or software (2) integrated in the user terminal and managing at least one device to send an identification request to identify the operator of at least one call number, and at least one device to receive a reply to the identification request, a platform managing identifications of the operator of at least one call number, this platform including at least one interface to receive requests and one interface to transmit replies, and an identification server linked to C.R.M.D. equipment (Common Remote Mobility Directory), the identification server being the priority interface of the C.R.M.D. equipment, a communication network between the different components of the system.

### CROSS REFERENCE TO RELATED APPLICATIONS

This application claims priority to and the benefit of French patent application Ser. No. 07/03916, filed on Jun. 1, 2007, the disclosure of which is incorporated herein by reference in its entirety.

### BACKGROUND

1. Field

The disclosed embodiments concern the area relating to identification systems of telephone operators or access providers, and more specifically the area of systems to identify the operator or Internet access provider managing the telephone communications of a call, and systems associating an identification element of the operator or access provider with the number of a call.

2. Brief Description of Related Developments

Telephone operators frequently have promotional offers encouraging users to multiply calls towards calls using the same operator. Calls made inside the operator's network are therefore invoiced in far more advantageous manner than calls made outside the network i.e. towards calls using a different telephone operator to the user. For users wishing to take full advantage of this type of so-called <<on net>> offer, it is essential that they are able to know the operators of their different calls.

At the current time, the only known solution for mobile telephony users wishing to overcome this problem consists of asking each of their contacts which operator they respectively use, and then to learn this information by heart to keep it in mind.

### SUMMARY

The aspects of the disclosed embodiments are directed to a system which facilitates firstly the obtaining of information on the operator or Internet access provider offering at least one telephony service used by a call's terminal, and secondly the memorizing of this information.

In one embodiment, a system identifies the operator or Internet access provider offering at least one telephony service for at least one call number memorized in the user's terminal, characterized in that the system includes:

at least one user terminal including at least one memory integrated in or associated with the terminal, comprising a directory of call numbers of the user's contacts,

a SIM Tool Kit application or software integrated in the user terminal and managing at least one send device to send an identification request to identify the operator or Internet access provider of at least one call number, and at least one receiver device to receive a reply to the identification request,

a platform managing the identifications of the operator or Internet access provider of at least one call number, this platform including at least one request receiving interface and one reply transmitting interface, as well as an identification server linked with at least one item of equipment forming a database which integrates an association between call numbers and a telephone operator or Internet access provider,

a communication network between the different components of the system and including one or more characteristic elements of a network.

According to one variant of the disclosed embodiments, the system identifying an operator or an Internet access provider is characterized in that the terminal includes memory means which integrate a table associating an element of reply to the request in the form of a code representing at least one operator or Internet access provider and/or an error, with a pictogram.

According to another variant of the disclosed embodiments, the system identifying an operator or Internet access provider is characterized in that the identification management platform is provided with means to place requests on standby which integrates temporary memory means of F.I.F.O. type (First In First Out).

According to another variant of the disclosed embodiments, the system to identify an operator or Internet access provider is characterized in that the identification server includes a device to create provisional accounts and/or sub-accounts in memory means, these accounts and/or sub-accounts being respectively associated with a request and defined firstly by the call number of the call for whom the user wishes to know the operator or Internet access provider, and secondly by the call number of the user to which a reply to the request is to be sent.

According to another variant of the disclosed embodiments, the system identifying an operator or Internet access provider is characterized in that, if the communication network includes an SMS-C (Short Message Service Center) ensuring communication between the user terminal and the identification management platform, the SIM Tool Kit application or the software of the user terminal is associated with means to write an SMS containing the number of a call of the user whose operator or Internet access provider it is desired to identify.

According to another variant of the disclosed embodiments, the system identifying an operator or an Internet access provider is characterized in that, if the network includes a gateway device for managing communication i.e. a WAP (Wireless Application Protocol) or 3G ensuring communication between the user terminal and the identification management platform, the SIM Tool Kit application or software of the user terminal is associated with means to transfer a file integrating at least one number of a call of the user whose operator or Internet access provider it is wished to identify.

According to another variant of the disclosed embodiments, the system identifying an operator or Internet access provider is characterized in that the database consisting of all matched associations for at least one country between call numbers and their respective operator or Internet access provider in charge of the contract integrating this call number, forms a C.R.M.D. (Common Remote Mobility Directory), this C.R.M.D. being associated with a device including:

a request receiving interface, associated with a provisional account transmitted by the identification server,

look-up means into at least one database of the C.R.M.D.,

means to write a reply to the received request, and

an interface to transmit a written reply to the provisional account of the identification server which corresponds to the request.

According to another variant of the disclosed embodiments, the system identifying an operator or Internet access provider is characterized in that the identification server comprises means to control the processing of all the requests corresponding to one same provisional account, this control means including at least one counter to count the number of C.R.M.D. request inputs/outputs.

According to another variant of the disclosed embodiments, the system identifying an operator or Internet access provider is characterized in that the reply to an identification request, which is transmitted to the terminal from the identification management platform, includes at least one identification code of the operator or Internet access provider and/or a pictogram identifying the same operator/Internet access provider.

In another aspect, the disclosed embodiments are directed to a method which allows the proper functioning of said system.

In one embodiment the method identifies the operator or Internet access provider of at least one call number stored in memory in a user terminal using an identification system of the invention, characterized in that the method includes at least:

a selection step to choose at least one call number whose operator or Internet access provider it is sought to determine,

a step, managed by the SIM Tool Kit application or the software, to send a request for identification of the operator or Internet access provider of at least one call number of the user from the user's terminal,

a receiving step to receive the request at the management platform identifying the operator or Internet access provider,

an analysis step of the request at the identification management platform,

a step to send a reply to the request for operator or Internet access provider identification, sent from the identification management platform to the user terminal,

a reaction step by the SUM Tool Kit application or software of the user terminal.

According to one variant of the disclosed embodiments, the method to identify an operator or Internet access provider is characterized in that it includes:

a step, managed by the SIM Tool Kit application or by the software, to write a request for identification of the operator or Internet access provider of at least one call number chosen by the user, this request consisting of a message or file including at least the number of the user terminal,

a step to write a reply to the identification request at the identification management platform.

According to another variant of the disclosed embodiments, the method to identify an operator or Internet access provider is characterized in that the analysis step of the request at the management platform includes:

a step to manage the request at the management platform, defining a request for each call number whose operator or Internet access provider is to be identified,

a step to process at least one request in at least one of the databases consisting of all matched associations, for a given country, between call numbers and their respective operator or Internet access provider.

According to another variant of the disclosed embodiments, the method to identify an operator or Internet access provider is characterized in that, if the request sent from the terminal concerns several call numbers, the request managing step includes:

a step to create a provisional account in memory means associated with the identification server, for each user number making a request,

a step to create at least one provisional sub-account for each call number for which the operator or Internet access provider is to be identified,

a step to define a look-up request for each call number associated with a sub-account,

a step to transmit the request to the C.R.M.D. which manages processing of the request in at least one database consisting of all matched associations, for a given country, between call numbers and their respective operator or Internet access provider.

According to another variant of the disclosed embodiments, the method to identify an operator or Internet access provider is characterized in that, if the request sent from the terminal concerns a single call number, the management step of the method includes:

a step to place the request on standby at buffer memory means of F.I.F.O. type,

a step to define a look-up request for the call number awaiting processing,

a step to transmit the request to the C.R.M.D. which manages processing of the request.

According to another variant of the disclosed embodiments, the method to identify an operator or Internet access provider is characterized in that the step to process the request at the C.R.M.D. includes:

a look-up step in the database consisting of all matched associations between call numbers and their respective operator or Internet access provider, to find the operator or Internet access provider of the call number corresponding to the request,

a step to write a reply to the request including an element of identification or error associated with the processed call number,

a step to transmit the reply to the provisional account of the identification server.

According to another variant of the disclosed embodiments, the method to identify an operator or Internet access provider is characterized in that the steps to manage the request and process the request are conducted concomitantly at a step controlling the processing of all requests corresponding to one same provisional account, this control step including at least one counting step to count the requests transmitted to the C.R.M.D. and the replies received from the C.R.M.D.

According to another variant of the disclosed embodiments, the method to identify an operator or Internet access provider is characterized in that the step to send a reply from the identification management platform to the user terminal consists of sending an element of S.M.S. type to the SIM Tool Kit application or to the software.

According to another variant of the disclosed embodiments, the method to identify an operator or Internet access provider is characterized in that the step to send a reply from the identification management platform towards the user terminal concerns the sending of a link accessible from the terminal equipped with a W.A.P. or 3G connection, this step is then followed by:

a downloading step by the user terminal of a file comprising at least one reply element corresponding to a call number for which a search for an operator or Internet access provider has been made,

a step to delete the provisional account from the memory means of the management platform.

According to another variant of the disclosed embodiments, the method to identify an operator or Internet access provider is characterized in that the reply element for each call number for which a search has been made forms a code whether or not accompanied by a pictogram representing an operator or Internet access provider and/or an error, and the reaction step of the SIM Tool Kit application or the software includes:

a step to record the received code and corresponding pictogram in reply for each call number whose operator or Internet access provider has been searched, the pictogram not yet being recorded in memory means of the SIM card, software or terminal, or

a step to decipher the code received in reply for each call number whose operator or Internet access provider has been searched, the code corresponding to a pictogram recorded in memory means of the SIM card, software or terminal, and

a step to activate a pictogram corresponding to a reply-code connected with a call number,

a step to display at the terminal at least one pictogram corresponding to the operator or Internet access provider of the call number for which a reply has been received.

According to another variant of the disclosed embodiments, the method to identify an operator or Internet access provider is characterized in that the reply element for each call number for which a search has been made forms a pictogram representing an operator/Internet access provider, or representing an error, and the reaction step by the SIM Tool Kit application or software includes:

a step to display at the terminal at least one pictogram corresponding to the operator or Internet access provider of the call number for which a reply has been received, or to display a message, a code and/or error pictogram.

According to another variant of the disclosed embodiments, the method to identify an operator or Internet access provider is characterized in that, when the number for which a look-up request has been made is a foreign number not included in the national C.R.M.D bases, the error code is replaced by a connection address to a C.R.M.D. which corresponds to the foreign country of the number.

According to another variant of the disclosed embodiments, the method to identify an operator or Internet access provider is characterized in that, if the number for which a look-up request is made is a foreign number not included in the national C.R.M.D. bases, the method includes:

a step to discriminate the country code of the searched number,

a step to transmit the country code of the searched number to supranational remote directory equipment I.R.M.D. (International Remote Mobility Directory) integrating a table which includes matched associations between country codes and the addresses of national C.R.M.Ds, the I.R.M.D. being interconnected with all national C.R.M.D.s,

a step by the I.R.M.D. to write and send a request to the C.R.M.D. corresponding to the country code of the searched number,

a step by the C.R.M.D. to write and send a reply to the I.R.M.D. request, the reply containing at least one searched number and indication by a code, whether associated or not with a pictogram of the foreign operator, corresponding to the searched number,

a step to update the sub-account corresponding to the searched foreign number.

According to another variant of the disclosed embodiments, the method to identify an operator or Internet access provider is characterized in that, the provisional account being held in the memory means of the management platform, the method includes at least:

a step to update the association between a number and its operator/Internet access provider in at least one of the databases of the C.R.M.D.,

a step to search different formats for the number whose operator has been updated, having recourse to a table translating numbers into several, possible, known entry formats,

a step to search at least one sub-account corresponding to a number whose operator has been updated in a recognised entry format,

a step to modify the operator identification element in the sub-account associated with a call number whose association has been updated,

a step to transmit the new operator identification element to the terminal, whose number is associated with the provisional account.

### BRIEF DESCRIPTION OF THE DRAWINGS

The invention, with its characteristics and advantages will become more clearly apparent on reading the description given with reference to the appended drawings in which:

FIG. 1 is a diagram showing a variant installation of the association system of the invention,

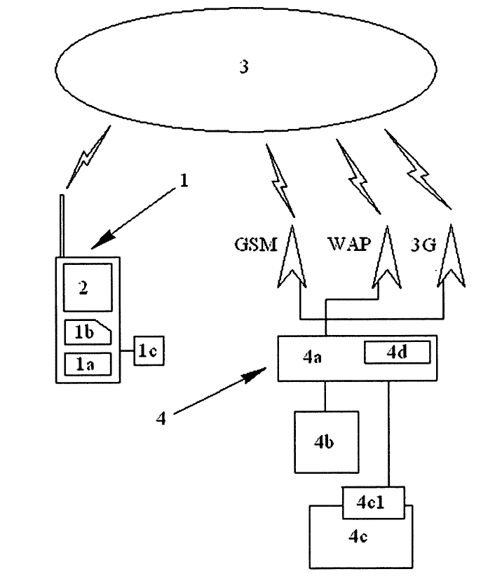

FIG. 2 is a diagram showing the different steps of a variant of the operating method of the invention.

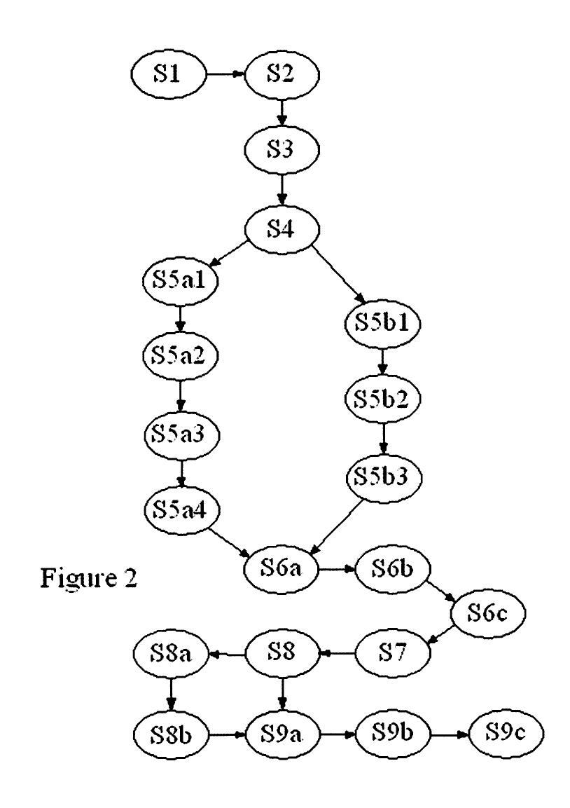

### DESCRIPTION OF THE DISCLOSED EMBODIMENTS

In the entirety of the document, the term <<operator>> is to be interpreted in its broad meaning. It therefore relates both to telephony operators, landline or mobile, and to Internet access providers who offer one or more telephony services, and also to radio paging operators.

Similarly the term <<C.R.M.D.>> (Common Remote Mobility Directory) does not restrictively define a device comprising a table associating mobile terminal numbers with their respective operator, but applies also to a device including one or more tables associating a terminal number, whether fixed or mobile, with its operator or Internet access provider.

The association system of the disclosed embodiments enables a user, from his/her terminal 1, to send a request to identify the operator managing at least one of the call numbers recorded in the SIM card memory 1b of the terminal 1 or in the own memory 1a of this terminal 1, even in an external memory 1c associated with the terminal 1. The user terminal 1 includes entry and display means enabling the user to make an identification request.

The system of the disclosed embodiments includes a SIM Tool Kit application or software 2 installed in the user terminal 1. This SIM Tool Kit application or software 2 is defined under the GSM standard as a means which particularly enables users to interact with their terminal 1. This application 2 manages communications between the terminal 1 on which it is installed and a platform 4 managing the identification of the operators of subscriber call numbers. Communication between the application 2 of the terminal 1 and the management platform 4 is made via a network 3 using installations characteristics of a mobile telephony communication network.

According to particular embodiments of the system of the invention, the network integrates at least one SMS-C. (Short Message System Center) adapted for the transfer of requests concerning a single call number and/or a WAP connection gateway (Wireless Application Protocol) and/or a 3G connection gateway adapted for the transfer of requests concerning groups of call numbers. These elements are therefore specific to a communication interface of the management platform 4.

The <<SIM Tool Kit>> application or software 2 in the terminal 1 manages firstly the sending of call number identification requests and secondly the replies to these requests. To do so, the application is associated with means to write and send requests. The writing of each of these requests is therefore controlled by the SIM Tool Kit application or software 2 in the form of a message or file transmitted from the terminal 1 to the identification management platform 4. The application (2) also controls the replies received from the platform 4 in association with a receiver device. This control can, if necessary, have recourse to a deciphering device associated with the SIM Tool application or software 2 if the reply includes at least one coded element of identification or error.

According to one variant of embodiment, the data transmitted in the network can have encryption of public key/private key type which may, for example, be stored in the SIM applet or software.

Additionally, when identification corresponds to display of the operator's pictogram next to the call number of the user's call, the SIM Tool Kit application or software 2 is associated with means to enter the pictograms of the respective operators of the call numbers into a memory 1a of the terminal 1, or 1b of the SIM card, or 1c associated with the terminal 1.

The identification management platform 4 identifying the operator of a call number, includes several elements. A first element forms the identification server 4a. This server 4a, which in particular has a communication interface with at least one terminal 1 of the system via a communication network 3, functions both to receive identification requests and to send replies to these requests towards the different terminals 1. The server 4a acts as interface between the network 3 and all the elements of the platform 4 managing associations. The identification server 4a is therefore linked with at least one database (4c) including all matched associations between call numbers and their respective operator, for a given country. With respect to mobile terminal numbers, this base of operator/number associations is called a Common Remote Mobility Directory C.R.M.D. These databases 4c, and more particular the C.R.M.D.s, are currently known at national level, but may fully well be developed on a supranational level (Europe, NAFTA area, etc.).

This C.R.M.D. 4c is associated with a device 4c1 which integrates at least one look-up means and also includes write means to write a reply and means to communicate with the identification server 4a within the identification management platform 4.

Also, according to one preferred embodiment, the management platform 4 includes memory means 4b linked to the identification server 4a. This memory 4b is used during the management of the different requests at the platform, in particular to create/delete provisional accounts, even sub-accounts. Said memory is adapted for the management of look-up requests concerning groups of call numbers.

According to another embodiment, the management platform 4 integrates a control device including counting means which verify in particular that the number of replies received by the identification server 4a is equal to the number of look-up requests transmitted to the C.R.M.D. 4c. This device can verify that received requests asking for identification of several call numbers were all looked up at step S6a before a reply is transmitted to the user terminal 1.

According to one variant of the disclosed embodiments, the management platform 4 integrates means 4d for placing successive requests on standby, including temporary memory means of F.I.F.O. type (First In First Out). Said memory is adapted for managing look-up requests concerning groups of call numbers.

The operating method of the system of the disclosed embodiments involves firstly a selection step S1 by the user, at his/her terminal 1, to choose at least one call number in memory for which it is desired to know the operator. This selection step S1 uses the SIM Tool Kit application or software 2 activated by the user via the display and entry means of the terminal 1.

Once the user has determined for which call number(s), in memory in the terminal 1, an operator identification is to be requested the <<SIM Tool Kit>> application or software 2 activates the writing S2 of an identification request. This request, depending on the chosen communication interface (S.M.S.-C or W.A.P. or 3G) with the identification management platform 4, can be in the form of a simple message or a file. In the different cases, this request is defined by at least one call number of the user whose operator is to be identified, and by the user's call number. Once the request is written S2, it is sent S3 from the terminal 1 to the management platform 4 via the network 3 used by the system of the invention.

When the request is received S4 at the management platform 4, it is analysed. It then undergoes a management step S5 amongst the different other requests received from terminals of other users, followed by a processing step S6 to offer a reply to the request.

According to a first variant of management step S5 which takes place at the identification server 4a, and for proper management of several requests, once the request is received it is placed on standby S5b1 in memory means 4d of F.I.F.O. type which act as buffer memory. For each identification request, a look-up request is then defined S5b2 for the call number awaiting processing. The request is then transmitted to the C.R.M.D. 4c which processes the request.

According to another variant, the management step S5 is adapted for look-up requests concerning groups of call numbers of one same user. A look-up request is defined for each of the call numbers whose operator is to be identified, within one same identification request made by one same user. This management step S5 is then initially performed by the creation S5a1 of a provisional account in memory means 4b of the management platform 4. This provisional account thus created is then referenced with the call number of the user terminal which made the request. In this provisional account a provisional sub-account is created S5a2 for each call number whose operator is to be identified, then a look-up request is defined S5a3 for each of the call numbers associated with a sub-account. When a request is defined, it is then transmitted S5a4 to the C.R.M.D. 4c for processing thereat.

For each of the variants of the management step S5 of the method of the invention, the defining of look-up requests for each call number requested by a user then makes it possible, in association with a buffer memory or with the creation of accounts/sub-accounts, to avoid duplication of look-ups for one same number.

The processing S6 of the request by the C.R.M.D 4c is intended to give a reply to the operator identification request. This processing step S6 is conducted initially by a look-up step S6a to find the operator of the call number which corresponds to the request. This look-up step S6a uses at least one look-up means associated with at least one database consisting of all matched associations between call numbers and their respective operator for a given country. This look-up step S6a uses at least a first call number discriminator so as to determine in which database investigation is to be made. For example, an identifier of the call number can be used to determine whether the search must be made in a base of geographical numbers of landline terminals (0Z), in a database of mobile terminal numbers (06), in a database of numbers offering services, in a database of foreign numbers, in a database of numbers offered by at least one Internet access provider, in a radio paging database, etc.

When a search S6a is made, a reply to the request is written (S6b). This reply then includes an identification element of the operator or of an error if the search S6a was unsuccessful. This element of reply is then associated firstly with the correspondent call number for which look-up was requested, and secondly with the user call number. This reply is then transmitted S6c to the identification server 4c of the management platform 4.

According to one variant of the method, the element of identification or error in the reply corresponds respectively to an activation code of a pictogram of the call number operator, or to an error code. Memory means integrated in the terminal 1 or SIM card 1b of the terminal, or possibly associated with the SIM Tool Kit application or software 2 of the terminal 1, include an association table matching each operator code or error code with a pictogram. However, in the C.R.M.D., memory means also include all the association tables between operator codes and associated pictograms. For any new operator, e.g. a M.V.N.O. (Mobile Virtual Network Operator) and/or when an association between a new operator code and a new pictogram has not yet been memorized in the association table of the memory means of the terminal 1, the identification element of the reply includes this new association transmitted in the form of a new operator code/pictogram pair.

According to one particular embodiment of the method, different error codes can be used, each one being specific to a particular error, e.g. when the call number whose operator has been searched is a landline number or a foreign mobile number, etc.

At the identification server 4c, each of the received replies is stored in the corresponding account/sub-account to verify the absence of any duplicates. A reply is then written S7 by the identification server 4c before being transmitted S8 to the user terminal 1 via the network 3 of the system.

Should one same look-up request include an operator search for several call numbers, the look-up request is provisionally saved in an account which carries the user call number and which includes several sub-accounts with one sub-account per requested call number. Only those sub-accounts which have one same user number entered in similar manner are considered to be duplicates. For example, a number entered under national format (01 23 45 67 89) is considered to be different to the same number entered under international format (33 1 23 45 67 89), the saving of these numbers then being made in different sub-accounts. Similarly, in the SIM Tool Kit application or software of the terminal, when a look-up is requested for several call numbers, if two users have different spellings (Dupond and Dupont) but have the same number, they are not considered as duplicates, but will effectively be transmitted to the management platform and will be saved in respective sub-accounts. The method of the invention then includes a control step S10 performed by a control device which verifies that all the requests in one same provisional account have been processed. This control S10 is made continuously, in parallel with the management S5 and processing S6 steps. It uses counting means which verify in particular that the number of requests transmitted to the C.R.M.D. 4c is equal to the number of replies given to the identification server 4a by the C.R.M.D., thereby enabling the management platform 4 only to transmit S8 to the terminal 1 a single reply which encompasses the results of searches into all the call numbers in the request, this reply only being transmitted S8 once the control step S10 has been successfully completed.

Depending on the type of interface used, and in general on the number of look-up requests made for one same identification request, the reply sent S8 by the identification server does not have the same form. If the identification request only concerns identification of the operator of a reduced number of call numbers, the reply is generally given in the form of a message of S.M.S. type. On the other hand, for an identification request concerning a high number of call numbers transmitted to the server 4a in the form of a file via a W.A.P. or 3G gateway, the reply is in the form of a link from which the user of the terminal 1 must carry out a download step S8a of a file containing the replies to each of the call numbers for which identification has been requested. A file must therefore be downloaded by the user terminal 1 for each provisional account created. Once the file has been downloaded S8qa by the user, the provisional account is deleted S8b from memory 4b.

When the replies for each of the call numbers are received by the terminal 1, the SIM Tool Kit application or software 2 reacts S9. If the replies correspond to error codes or pictogram activation, this reaction may initially include a deciphering step S9a of the codes received for each call number for which the operator has been searched. Once the reply is deciphered, the pictogram corresponding to the reply-code received is activated S9b. If it is a reply code which corresponds to an operator, the operator's pictogram is then displayed S9c with the call number of the user's call. Similarly, if it is a particular error code, a pictogram specific to the error is associated with the number giving rise to this error code.

According to one variant of embodiment, when the number for which a look-up request has been made is a foreign number not present in the national C.R.M.D. base, the error code may activate the display of an address connecting to a C.R.M.D. base which corresponds to the foreign country of the number. Alternatively, the country code of the searched foreign number is discriminated and transmitted to supranational equipment I.R.M.D. (International Remote Mobility Directory). This equipment is associated with or integrates a table which comprises the associations between country codes and addresses of national C.R.M.D. bases with which the I.R.M.D. is interconnected. The I.R.M.D. then sends a request to the C.R.M.D. which corresponds to the country code of the searched number to determine the operator of the searched number. The C.R.M.D. replies to the request by a message containing at least one searched number and a coded indication, which may or may not be associated with the pictogram of the foreign operator, corresponding to the searched number. This information is transmitted to the identification server 4c so that the sub-account corresponding to the searched foreign number can be updated.

Independently, it may be envisaged that the pictogram of the call number operator which is displayed, can be associated with the pictogram of the operator's country, if the call number corresponds to a foreign mobile terminal. That country's pictogram will then be activated on receipt by the terminal 1 of a code specific to the C.R.M.D. of the country in which a match, with the call number for which look-up was requested, has been found.

The updating of matched associations between an operator identification element and the call number may be made by regular, parameterised activation of an update request controlled by the SIM Tool Kit application or software 2 of the terminal 1. This update is made by sending an update request to the management platform in similar manner to the sending of a usual look-up request. Updating may also be prompted regularly by opening a query window in the display device of the terminal, controlled by the terminal application or software.

According to one variant of the updating method, the provisional account and all the sub-accounts are held in the memory of the memory means of the management platform. When the association between a call number and its operator/Internet access provider is updated in at least one of the databases of the C.R.M.D., the operator identification element of the sub-accounts associated with the call number whose association has been updated, is then searched and modified in all the sub-accounts in which it is present, irrespective of the entry format (national or international). For this purpose, a table translating a number into several, possible, acceptable formats is used to define the search criteria in the sub-accounts in as many chains of characters possible to conduct the search.

This modification is made in each of the sub-accounts in memory means that are associated with the call number. In the kept provisional account carrying the user call number, the modification of the identification element in one of the sub-accounts leads to transmission of the new operator identification element towards the terminal whose call number is associated with the provisional account.

It will be obvious for those skilled in the art that the disclosed embodiment allows embodiments in numerous other specific forms without departing from the area of application of the invention such as claimed. Therefore, the present embodiments are to be considered as illustrations which may be modified within the area defined by the scope of the appended claims.

1. A System to identify the operator or Internet access provider offering at least one telephony service for at least one call number memorized in the terminal (1) of a user, wherein the system comprises:
at least one user terminal (1) comprising at least one memory (1a, 1b) integrated in or associated (1c) with the terminal (1) comprising a directory of call numbers of the user's calls.
a SIM Tool Kit application or software (2) integrated in the user terminal (1) and managing at least one device to send an identification request to identify the operator or Internet access provider of at least one call number, and at least one device to receive a reply to the identification request,
a management platform (4) managing identifications of the operator or Internet access provider of at least one call number, this platform (4) comprising at least one request receiving interface and one reply transmitting interface, and an identification server (4a) linked to at least one item of equipment forming a database which integrates matched associations between call numbers and a telephony operator or an Internet access provider,
a communication network (3) between the different components of the system and comprising one or more characteristic elements of a network.

2. The system to identify an operator or Internet access provider according to claim 1, wherein the terminal (1) comprises memory means which integrate an association table which associates an element of reply to a request, in the form of a code representing at least one operator or Internet access provider and/or an error, with a pictogram.

3. The system to identify an operator or Internet access provider according to claim 1, wherein the identification management platform (4) is provided with means (4d) to place requests on standby, integrating temporary memory means of F.I.F.O. type (First In First Out).

4. The system to identify an operator or Internet access provider according to either of claim 1, wherein the identification server (4a) comprises a device to create provisional accounts and/or sub-accounts in memory means (4b), these accounts and/or sub-accounts, respectively associated with a request, are defined firstly by the call number for which the user wishes to know the operator or Internet access provider, and secondly by the call number of the user to which a reply to the request is to be sent.

5. The system to identify an operator or Internet access provider according to claim 1, wherein, if the communication network (3) comprises a S.M.S.-C (Short Message Service Center) ensuring communication between the user terminal (1) and the identification management platform (4), the SIM Tool Kit application or the software (2) of the user terminal (1) is associated with means to write a S.M.S. containing the call number of a user whose operator or Internet access provider is to be identified.

6. The system to identify an operator or Internet access provider according to claim 1, wherein, if the network (3) comprises a gateway device for managing communication, W.A.P. (Wireless Application Protocol) or 3G ensuring communication between the user terminal (1) and the identification management platform (4), the SIM Tool Kit application or software (2) of the user terminal (1) is associated with means to transfer a file integrating at least one call number of the user whose operator or Internet access provider is to be identified.

7. The system to identify an operator or Internet access provider according to claim 1 wherein, the database consisting of all associations, for at least one country, between call numbers and their respective operator or Internet access provider in charge of the contract integrating this call number forming a C.R.M.D. (Common Remote Mobility Directory), the C.R.M.D. is associated with a device (4c1) comprising:
an interface to receive a request associated with a provisional account, transmitted by the identification server,
look-up means into at least one database of the C.R.M.D. (4c),
means to write a reply to the received request, and
an interface to transmit a written reply to the provisional account of the identification server corresponding to the request.

8. The system to identify an operator or Internet access provider at least according to claim 4, wherein the identification server (4a) comprises means to control the processing of all requests corresponding to one same provisional account, this control means comprising at least one counter to count the number of C.R.M.D. request inputs/outputs (4c).

9. The system to identify an operator or Internet access provider according to claim 1 wherein reply to the identification request, which is transmitted to the terminal from the identification management platform, comprises at least one identification code of the operator or Internet access provider, and/or an identification pictogram of the same operator/Internet access provider.

10. A method to identify an operator or Internet access provider of at least one call number in memory in a user terminal comprising:
a step (S1) to select at least one call number whose operator or Internet access provider is to be determined,
a step (S3), managed by the SIM Tool Kit application or software (2), to send an identification request to identify the operator or Internet access provider of at least one call number of the user, from the user terminal (1),
a step (S4) to receive the request at the platform (4) managing identifications of the operator or Internet access provider,
a step to analyse the request at the identification management platform,
a step (S8) to send a reply to the request to identify the operator or Internet access provider, sent from the identification management platform (4) to the user terminal (1),
a reaction step (S9) by the SIM Tool Kit application or software (2) of the user terminal (1).

11. The method to identify an operator or Internet access provider according to claim 10, further comprising:
a step (S2), managed by the SIM Tool Kit application or by the software (2), to write an identification request to identify the operator or Internet access provider of at least one call number chosen by the user, this request formed of a message or file including at least the number of the user terminal (1),
a step (S7) to write a reply to the identification request by the identification management platform (4),

12. The method to identify an operator or Internet access provider according to claim 10, wherein the step to analyse the identification request at the management platform (4) comprise:
a step (S5) to manage the identification request at the management platform (4) defining a look-up request for each call number whose operator or Internet access provider is to be identified,
a step (S6) to process at least one look-up request in at least one database consisting of all the associations, for a given country, between call numbers and their respective operator or Internet access provider.

13. The method to identify an operator or Internet access provider according to claim 12, wherein, if the identification request sent from the terminal (1) concerns several call numbers, the step (S5) to manage this request comprise:
a step (S5a1) to create a provisional account in a memory means (4b) associated with the identification server (4a) for each user number making a request,
a step (S5a2) to create at least one provisional sub-account for each call number whose operator or Internet access provider is to be identified,
a step (S5a3) to define a look-up request for each call number associated with a sub-account,
a step (S5a4) to transmit the look-up request to the C.R.M.D. (4c) which manages processing of the request in at least one database consisting of all the associations, for a given country, between call numbers and their respective operator or Internet access provider.

14. The method to identify an operator or Internet access provider according to claim 12 wherein, if the identification request sent from the terminal (1) only concerns a single call number, the management step (S5) of the method comprise:
a step (S5b1) to place the request on standby in buffer memory means (4d) of F.I.F.O. type,
a step (S5b2) to define a look-up request for the call number awaiting processing,
a step (S5b3) to transmit the look-up request to the C.R.M.D. (4c) which manages processing of the request.

15. The method to identify an operator or Internet access provider according to claim 10, wherein the step (S6) to process the look-up request at the C.R.M.D. (4c) comprise:
a look-up step (S6a) in the database consisting of all the associations between call numbers and their respective operator or Internet access provider, to find the operator or Internet access provider of the call number corresponding to the request,
a step (S6b) to write a reply to the look-up request comprising an element of identification or error associated with the processed call number,
a step (S6c) to transmit the reply to the provisional account of the identification server (4a).

16. The method to identify an operator or Internet access provider according to claim 12, wherein, the management (S5) and processing (S6) steps of the look-up request are conducted concomitantly at a step (S10) controlling the processing of all the requests relating to one same provisional account, this control step (S10) comprising at least one counting step to count the requests transmitted to the C.R.M.D. (4c) and the replies received from the C.R.M.D. (4c).

17. The method to identify an operator or Internet access provider according to claim 10 wherein the step (S8) to send a reply from the identification management terminal (4) to the user terminal (1) consists of sending an element of S.M.S. type to the SIM Tool Kit application or software (2).

18. The method to identify an operator or Internet access provider according to claim 10 wherein the step (S8) to send a reply from the identification management platform (4) to the user terminal (1) concerns the sending of a link accessible from the terminal (1) equipped with a W.A.P. or 3G connection, this step then being followed by:
a downloading step (S8a) by the user terminal (1) to download a file comprising at least one element of reply corresponding to a call number for which a search for the operator or Internet access provider has been made,
a step (S8b) to delete the provisional account from the memory means (4b) of the management platform (4).

19. The method to identify an operator or Internet access provider according to claim 10, wherein the element of reply for each call number for which a search has been made forms a code, whether or not accompanied by a pictogram representing an operator or Internet access provider and/or representing an error, and the reaction step (S9) of the SIM Tool Kit application or software (2) comprise:
a step (S9a) to record the code and corresponding pictogram received in reply for each call number whose operator or Internet access provider was searched, the pictogram not yet being recorded in memory means of the SIM card, of the software or of the terminal, or
a deciphering step (S9a bis) of the code received in reply for each call number whose operator or Internet access provider has been searched, the code corresponding to a pictogram recorded in memory means of the SIM card, of the software or of the terminal, and
a step (S9b) to activate a pictogram corresponding to a reply-code related to a call number,
a step (S9c) to display at the terminal (1) at least one pictogram corresponding to the operator or Internet access provider of the call number for which a reply has been received.

20. The method to identify an operator or Internet access provider according to claim 10, wherein the element of reply for each call number for which a search has been made forms a pictogram representing an operator/Internet access provider, or representing an error, the reaction step of the SIM Tool Kit application or of the software comprising:
a step to display (S9c) at the terminal at least one pictogram corresponding to the operator or Internet access provider of the call number for which a reply has been received, or to display a message, a code and/or an error pictogram.

21. The method to identify an operator or Internet access provider according to claim 10, wherein, if the number for which a look-up request has been made is a foreign number not included in the national C.R.M.D. bases, the error code is replaced by a connection address to a C.R.M.D. which corresponds to the foreign country of the number.

22. The method to identify an operator or Internet access provider according to claim 10, characterized in that, if the number for which a look-up request is made is a foreign number not included in national C.R.M.D. bases, the method comprise:
a step to discriminate the country code of the searched number,
a step to transmit the country code of the searched number to supranational I.M.R.D. equipment (International Remote Mobility Directory) integrating a table which matches country codes and national C.R.M.D. addresses, the I.M.R.D. being interconnected with all national C.R.M.D.s,
a write and send step of a request by the I.M.R.D. sent to the C.R.M.D. corresponding to the country code of the searched number,
a write and send step of a reply by the C.R.M.D. to the request sent by the I.M.R.D., the reply containing at least one searched number and the coded indication, whether or not associated with a pictogram, of the foreign operator which corresponds to the searched number,
a step to update the sub-account corresponding to the searched foreign number.

23. The method to identify an operator or Internet access provider according to claim 10, wherein, if the provisional account is held in the memory means (4b) of the management platform (4), the method comprises at least:
a step to update the association between a number and its operator/Internet access provider in at least one of the databases of the C.R.M.D.,
a step to search different formats for the number whose operator has been updated, using a table translating a number into several, possible, known entry formats,
a step to search at least one sub-account corresponding to a number whose operator has been updated in a recognized entry format,
a step to modify the operator identification element in the sub-account associated with a call number whose association has been updated,
a step to transmit a new operator identification element to the terminal (1) whose number is associated with the provisional account.
